(19) United States
(12) Patent Application Publication
(10) Pub. No.: US 2021/0019381 A1
(43) Pub. Date: Jan. 21, 2021

(54) LICENSE MANAGEMENT SYSTEM AND NON-TRANSITORY COMPUTER READABLE MEDIUM

(71) Applicant: FUJI XEROX CO., LTD., Tokyo (JP)

(72) Inventor: Yoshio KURIMURA, Kanagawa (JP)

(73) Assignee: FUJI XEROX CO., LTD., Tokyo (JP)

(21) Appl. No.: 16/744,435

(22) Filed: Jan. 16, 2020

(30) Foreign Application Priority Data
Jul. 18, 2019 (JP) 2019-132819

(51) Int. Cl. G06F 21/10; G06F 8/73; G06F 8/71

(52) U.S. Cl. CPC G06F 21/105; G06F 8/71; G06F 8/73

(57) ABSTRACT

A license management system includes a generating unit that generates first information to identify a version of an application program in use; and a transmitting unit that transmits the first information to a manager.

### CROSS-REFERENCE TO RELATED APPLICATIONS

This application is based on and claims priority under 35 USC 119 from Japanese Patent Application No. 2019-132819 filed Jul. 18, 2019.

### BACKGROUND

### (i) Technical Field

The present disclosure relates to a license management system and a non-transitory computer readable medium.

### (ii) Related Art

Forms of license contracts of application programs include forms of giving licenses to individual users and forms of giving licenses to organizations. The forms of giving licenses to organizations include providing an authority to a manager of an organization to give a license to a user in the organization. Japanese Unexamined Patent Application Publication No. 2016-173715 suggests a scheme for managing various forms of license contracts.

### SUMMARY

An application program installed in each terminal may be individually upgraded by a user of the terminal. In this case, the user who has performed the upgrading work knows the current version of the application program.

However, a manager of an organization and a manager of a provider that provides the application program do not know the version of the application program installed in the individual terminal that is operated by the user.

Thus, even when an application program of a version which may cause a serious malfunction in the use environment of the user is left without being updated, or when an application program of a version which is no longer supported remains in the terminal, the managers do not notice the state.

Aspects of non-limiting embodiments of the present disclosure relate to allowing a manager to check the version of an application program installed in a terminal that is used by an individual user.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a license management system including a generating unit that generates first information to identify a version of an application program in use; and a transmitting unit that transmits the first information to a manager.

### BRIEF DESCRIPTION OF THE DRAWINGS

An exemplary embodiment of the present disclosure will be described in detail based on the following figures, wherein:

FIG. 1 illustrates an example of a system configuration of an information processing system according to an exemplary embodiment;

FIG. 2 illustrates an example of functions provided in a server and a terminal apparatus constituting the information processing system;

FIG. 3 illustrates an example of a data structure under license contract;

FIG. 4 illustrates an example of a data structure when it is verified that authenticity of a version in use is doubtful;

FIG. 5 illustrates an example of another data structure when a version in use is doubtful;

FIG. 6 illustrates an example of a data structure when a licensee is a tenant;

FIG. 7 illustrates a process of generating an application object to be executed between the server and a first terminal apparatus that is used by a vendor that provides an application;

FIG. 8 illustrates a process of generating a version object to be executed between the server and the first terminal apparatus that is used by the vendor that provides the application;

FIG. 9 illustrates a process of generating a license object to be executed between the server and the first terminal apparatus that is used by the vendor that provides the application;

FIG. 10 illustrates a process of displaying a license-related management screen to be executed between the server and the first terminal apparatus that is used by the vendor that provides the application; and

FIG. 11 illustrates an example of the license-related management screen.

### DETAILED DESCRIPTION

An exemplary embodiment of the disclosure is described below with reference to the drawings.

### Exemplary Embodiment

### System Configuration

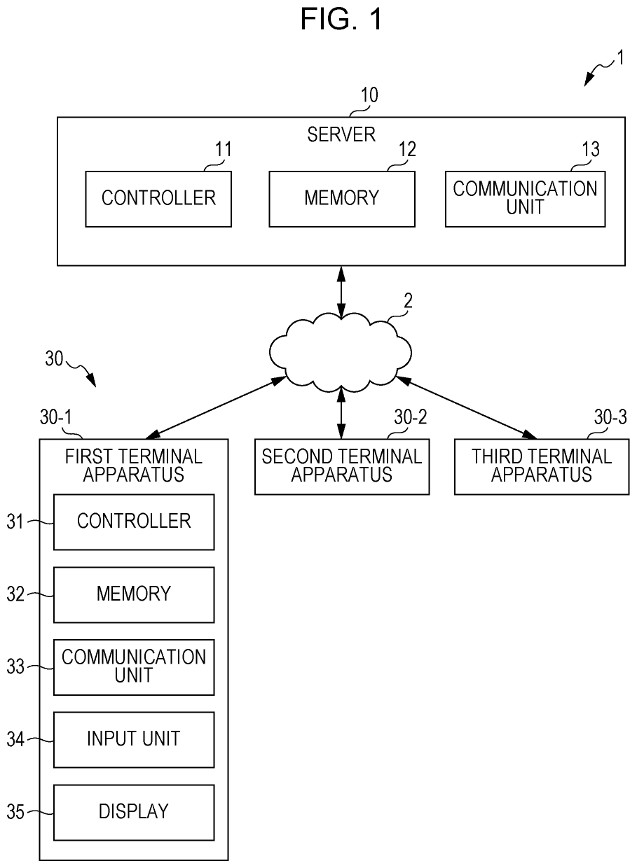

FIG. 1 illustrates an example of a system configuration of an information processing system 1 according to an exemplary embodiment.

The information processing system 1 illustrated in FIG. 1 includes a server 10, a first terminal apparatus 30-1, a second terminal apparatus 30-2, and a third terminal apparatus 30-3.

The server 10, the first terminal apparatus 30-1, the second terminal apparatus 30-2, and the third terminal apparatus 30-3 are communicable to one another via a network 2.

In this exemplary embodiment, the first terminal apparatus 30-1 is used by a vendor that is a licenser of an application program (hereinafter, referred to as “application”), the second terminal apparatus 30-2 is used by a licensee of the application, and the third terminal apparatus 30-3 is used by a manager of a tenant with which a contract of the application is made.

The tenant is a concept that is used when a license of an application is managed per organization or the like. One tenant is established for one contract.

The licensee according to the exemplary embodiment includes both cases of an individual and a tenant. When the licensee is a tenant, the manager of the tenant gives, in the range of a contract, a license to a user who participates in the tenant. Thus, the second terminal apparatus 30-2 includes both cases of a terminal that is operated by an individual as a licensee, and a terminal that is operated by an individual who participates in a tenant.

As described above, the information processing system 1 flexibly adapts to various license forms.

The exemplary embodiment uses a terminal apparatus 30 to collectively name the first terminal apparatus 30-1, the second terminal apparatus 30-2, and the third terminal apparatus 30-3.

The server 10 according to the exemplary embodiment is a computer that provides a service to provide the version of an application installed in the second terminal apparatus 30-2 to a manager of a vendor or a manager of a tenant. The server 10 is an example of a license management system.

The server 10 illustrated in FIG. 1 includes a controller 11, a memory 12, and a communication unit 13.

The controller 11 includes a central processing unit (CPU), a read only memory (ROM) storing a basic input output system (BIOS) and so forth, and a random access memory (RAM) used as a work area.

The controller 11 controls various arithmetic operations and actions of respective components constituting the apparatus through execution of programs stored in the memory 12.

The memory 12 stores information on the version and so forth of an application installed in the second terminal apparatus 30-2; and programs, such as basic software and the applications. The memory 12 includes, for example, a hard disk drive. Alternatively, the memory 12 may be a re-writable non-volatile semiconductor memory.

The communication unit 13 includes, for example, a network interface card (NIC) and is connected to the network 2 via the NIC.

The terminal apparatus 30 includes, for example, a controller 31, a memory 32, a communication unit 33, an input unit 34, and a display 35.

The controller 31 includes a CPU, a ROM, and a RAM. The controller 31 controls various arithmetic operations and actions of respective components constituting the apparatus through execution of programs stored in the memory 32.

The memory 32 stores programs, such as basic software and an application; and data handled by the basic software and the application. The memory 32 includes, for example, a hard disk drive. Alternatively, the memory 32 may be a re-writable non-volatile semiconductor memory.

The communication unit 33 includes, for example, an NIC and is connected to the network 2 via the NIC.

The input unit 34 includes an input device, such as at least one of a keyboard, a mouse, and a touch panel. The input unit 34 is used to receive an operation from a user.

The display 35 includes, for example, a liquid crystal display or an organic electro luminescence (EL) display. The display 35 displays an image that is generated by the controller 31.

Alternatively, the input unit 34 and the display 35 may be externally attached to the body of the apparatus, as a peripheral device of the terminal apparatus 30.

### Data Management by Server 10

The server 10 according to the exemplary embodiment manages an object based on a prototype. A prototype is an object that may generate a new child object. In the viewpoint of a child object, a parent object that has generated the child object is a prototype.

A prototype base indicates a method of handling an object based on a prototype. An object of a prototype base except a root object has one prototype. The root object is uniquely present in a set of objects. The root object does not have its own prototype.

When an object A is the prototype of an object B, the object B is referred to as an artifact or a child object of the object A.

A set of objects of a prototype base is expressed in a form of a tree structure in accordance with the prototype relation among the objects. The tree structure may be transformed by reconnecting a prototype unless the reconnection breaks the tree structure including objects.

An object that is managed by the server 10 may have an attribute and an attribute value.

In a representational state transfer (REST) architecture style, an object may be referred to as resource and a value may be referred to as expression.

An object includes at least one of information indicative of a pure identity simply including an object identifier and a prototype, information indicative of data having a content value, an access token including credential information that authenticates access credentials, and an application that makes an access to the object. An access token may be also referred to as an object associated with information on the authority to make an access.

One tree structure includes these objects.

A version token may be also referred to as an object associated with information for identifying the version of an application to be managed. The version token is an example of first information.

A license token may be also referred to as an object associated with information generated in accordance with the result of verifying authenticity of the version. The license token is an example of second information.

In this exemplary embodiment, having authenticity indicates that the version of an application to be managed is in a recommended state, or more specifically, that a combination of basic software and the version of an application to be managed is proper, that a combination of the version of an application in use and the version supported by a vendor is proper, or that the license for the version of an application to be managed is proper.

No problem arises for use of an application of a proper version; however, certain restriction is required for use of an application of an improper version.

In this exemplary embodiment, use of an improper application is controlled by two steps with regard to user's convenience.

One control is to limit the available period to the period required for, for example, updating or uninstalling the application, and the other control is to immediately inhibit the use of the application.

In the exemplary embodiment, the former control uses an access token with a time limit. Hereinafter, an access token with a time limit is referred to as interim Token.

Moreover, the latter control uses a suspension token. Hereinafter, a suspension token is referred to as hibernation Token.

The server 10 according to the exemplary embodiment, when the server 10 has successfully verified a token included in a request, processes the received request within the range of the authority (hereinafter, also referred to as “scope”) corresponding to the token. For example, the server 10 permits or does not permit one of generation of an object, reference of an object, update of an object, and deletion of an object, based on the scope specified using an access token.

Moreover, for example, the server 10 adds, updates, and deletes an object to be managed, and reads information from the object, in response to a request received from the terminal apparatus 30.

### Functions Implemented by Information Processing System 1

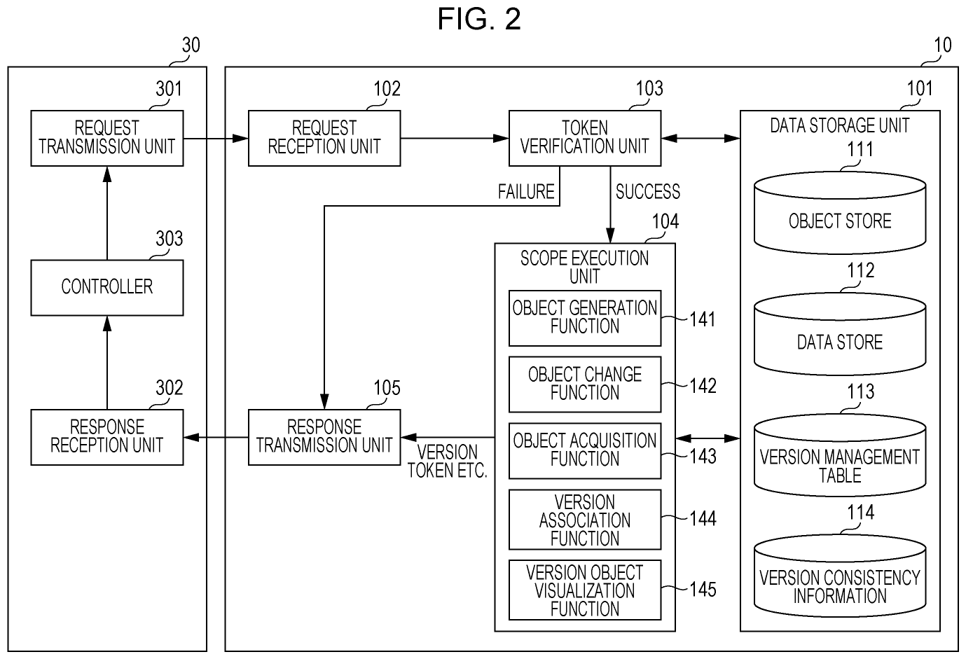

FIG. 2 illustrates an example of functions provided in the server 10 and the terminal apparatus 30 constituting the information processing system 1.

The server 10 illustrated in FIG. 2 includes a data storage unit 101 that manages information on an object of a prototype base, a request reception unit 102 that receives a request from the terminal apparatus 30, a token verification unit 103 that verifies a token included in the received request, a scope execution unit 104 that executes a scope extracted from a proper token which has been successfully verified, and a response transmission unit 105 that returns a result of executing the scope extracted from the request or a failure of the verification of the token to the terminal apparatus 30. The response transmission unit 105 is an example of a transmitting unit.

The data storage unit 101 stores object store 111 that stores an object, data store 112 that stores data, a version management table 113 to manage the version of an application installed in the terminal apparatus 30, and version consistency information 114 to manage the consistency of the version.

The scope execution unit 104 according to the exemplary embodiment includes plural sub-functions for processing a received request. Alternatively, the sub-functions may be provided partly separately from the scope execution unit 104.

One of the sub-functions is an object generation function 141.

The object generation function 141 generates a version object having, for example, a parent object that is an owner (that is, owner information) designated using a token. The object generation function 141 is an example of a generating unit.

Another one of the sub-functions is an object change function 142.

The object change function 142 changes a version object that is, for example, a child object of an owner designated using a token.

Still another one of the sub-functions is an object acquisition function 143.

The object acquisition function 143 acquires data of a value from an etag attribute when a revoked At attribute of a designated object is undefined. The etag attribute indicates identification information on a data object storing the data content of an object.

Yet another one of the sub-functions is a version association function 144.

The version association function 144 associates a version with a license. The version association function 144 is an example of an associating unit.

Yet another one of the sub-functions is a version object visualization function 145.

The version object visualization function 145 displays information on the version or license of an application onto a screen of the terminal apparatus 30 operated by the manager. The version object visualization function 145 is an example of a managing unit.

The terminal apparatus 30 illustrated in FIG. 2 includes a request transmission unit 301 that transmits a request to the server 10, a response reception unit 302 that receives a response from the server 10, and a controller 303 that controls, for example, display of a received response and generation of a new request.

### Specific Examples of Objects of Prototype Base

Data Structure when Licensee is User

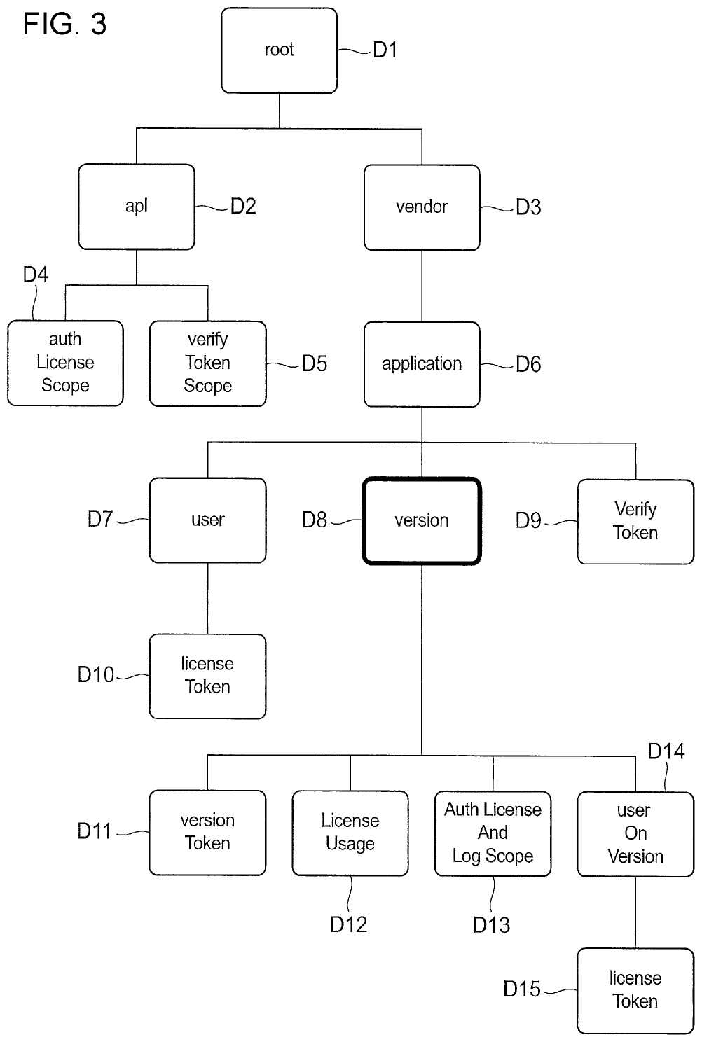

FIG. 3 illustrates an example of a data structure under license contract. Being under license contract indicates, for example, being at a timing at which charging for license contract is completed. The timing is an example when a license is contracted.

As described above, the relationship between a parent and a child of objects of a prototype base is expressed in a form of a tree structure.

Referring to FIG. 3, an “apl” object D2 and a “vendor” object D3 are provided as child objects of a “root” object D1. The “vendor” object D3 corresponds to a vendor of an application which is an object of license contract.

The “apl” object D2 is provided with, as its child objects, an “auth License Scope” object D4 and a “verify Token Scope” object D5.

The “auth License Scope” object D4 is an object corresponding to the scope of license authentication. The “verify Token Scope” object D5 is an object corresponding to the scope of token verification.

The “vendor” object D3 is provided with, as its child object, an “application” object D6.

The “application” object D6 is an object corresponding to an application which is an object of a license.

The “application” object D6 is further provided with, as its child objects, a “user” object D7, a “version” object D8, and a “Verify Token” object D9.

The “user” object D7 corresponds to a licensee. The “user” object D7 is provided with, as its child object, a “license Token” object D10. The “license Token” object D10 corresponds to a license given to a user.

The “version” object D8 is an object indicating the version of an application generated when a license is contracted. The “verify Token” object D9 is a token that verifies authenticity of a token included in a request, and is generated when the “application object” D6 is generated.

The “version” object D8 is provided with, as its child objects, a “version Token” object D11, a “License Usage” object D12, an “auth License And Log Scope” object D13, and a “user On Version” object D14.

The “License Usage” object D12 is an object indicating information used for determining validity of a license. The “user On Version” object D14 is an object corresponding to a licensed user. The “user On Version” object D14 is provided with, as its child object, a “license Token” object D15. The “license Token” object D15 is an object corresponding to a token indicating a license given to a user.

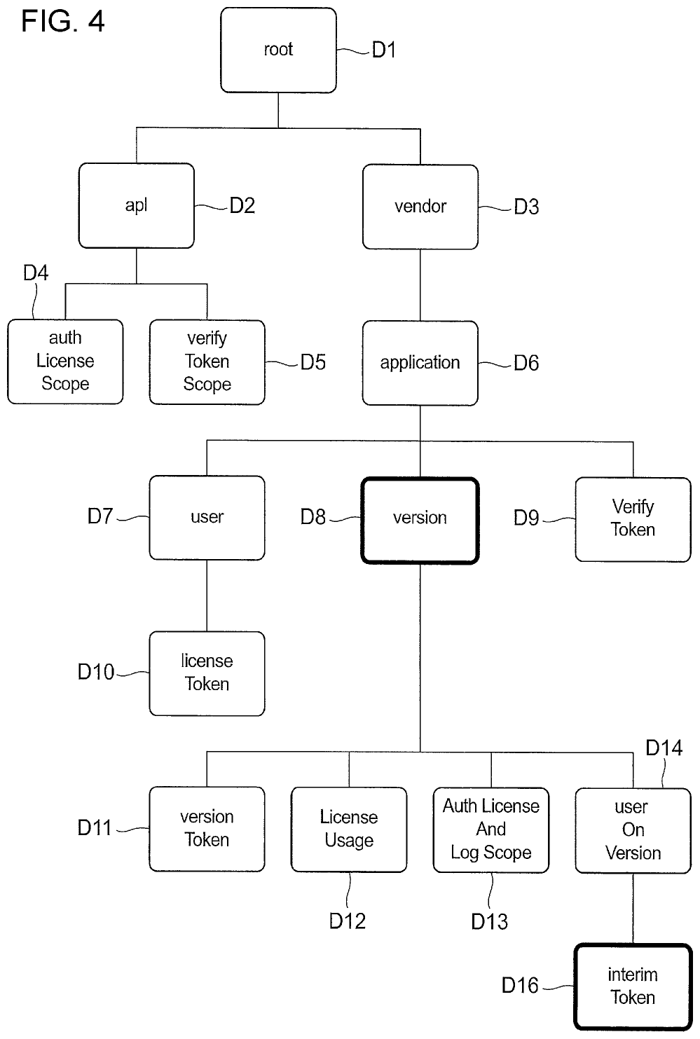

FIG. 4 illustrates an example of a data structure when it is verified that authenticity of a version in use is doubtful.

In FIG. 4, like reference signs are applied to like portions corresponding to those in FIG. 3.

FIG. 4 illustrates a data structure that is used when use of a user is under a temporary license with a time limit.

In FIG. 4, the content of the “license Token” object D15 in FIG. 3 is changed to an “interim Token” object D16. The “interim Token” object D16 is an object indicating a temporary license that permits a user to use the current version within a period required for updating or uninstallation.

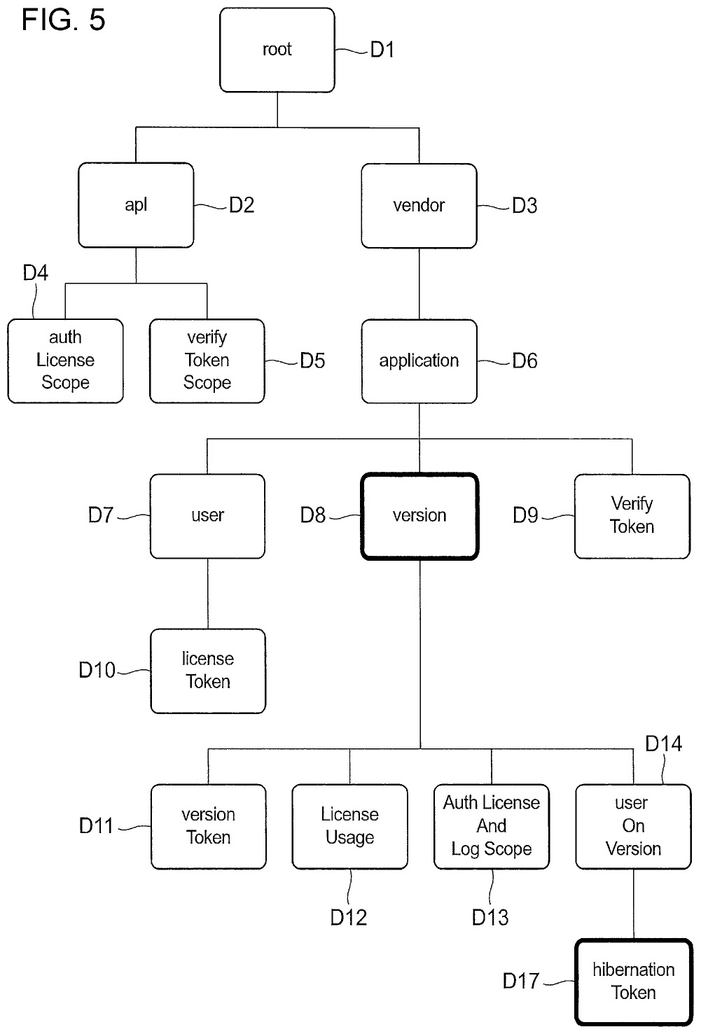

FIG. 5 illustrates an example of another data structure when a version in use is doubtful.

In FIG. 5, like reference signs are applied to like portions corresponding to those in FIG. 3.

FIG. 5 illustrates a data structure that is used when a suspension license is applied to a user.

In FIG. 5, the content of the “license Token” object D15 in FIG. 3 is changed to a “hibernation Token” object D17. The “hibernation Token” object D17 is an object indicating a suspension license that is used, for example, when use of an application of the current version is not permitted.

Data Structure when Licensee is Tenant

FIGS. 3 to 5 expect a case where the licensee is an individual. In contrast, a case where the licensee is a tenant is described now.

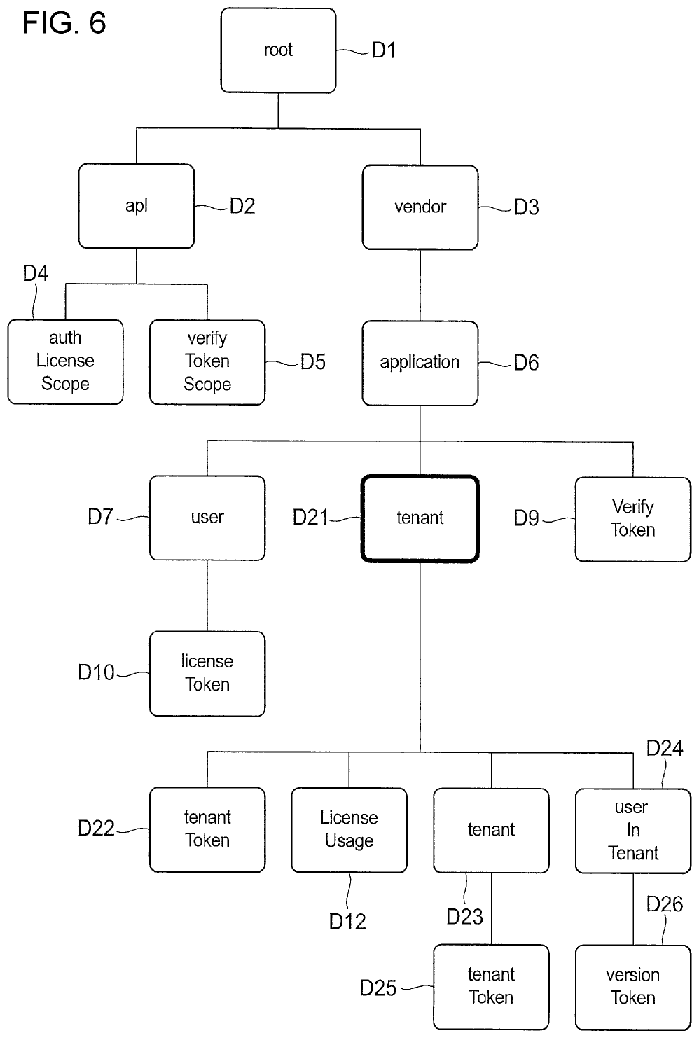

FIG. 6 illustrates an example of a data structure when a licensee is a tenant.

In FIG. 6, like reference signs are applied to like portions corresponding to those in FIG. 3. FIG. 6 illustrates an example of a data structure under license contract.

The data structure in FIG. 6 differs from the data structure in FIG. 3 in that a “tenant” object D21 is provided, as a child object of the “application” object D6, instead of the “version” object D8.

The “tenant” object D21 is an object corresponding to a tenant generated when the license is contracted.

The “tenant” object D21 is provided with, as its child objects, a “tenant Token” object D22, a “License Usage” object D12, a “tenant” object D23, and a “user In Tenant” object D24.

The “tenant Token” object D22 corresponds to a license given to a tenant.

The “tenant” object D23 is an object corresponding to a contractor of a tenant. The “tenant” object D23 is provided with, as its child object, a “tenant Token” object D25. The “tenant Token” object D25 corresponds to a license given to a tenant.

The “user In Tenant” object D24 is an object corresponding to a licensed user who belongs to a tenant. The “user In Tenant” object D24 is provided with, as its child object, a “version Token” object D26. The “version Token” object D26 corresponds to a token indicating a version given to a user in a tenant.

### Processing Operation Executed by Information Processing System 1

A specific example of a processing operation that is executed by the information processing system 1 is described below.

### Generation of Application Object

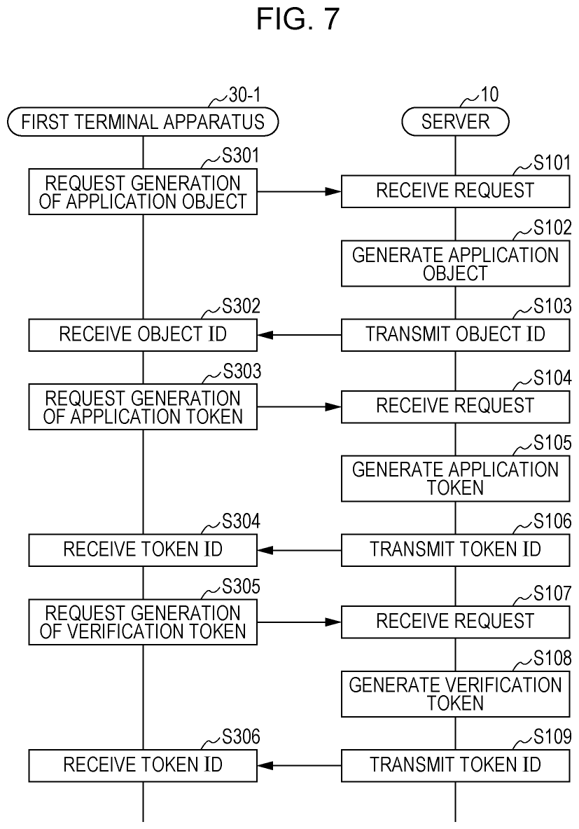

FIG. 7 illustrates a process of generating an application object to be executed between the server 10 and the first terminal apparatus 30-1 that is used by a vendor that provides an application. Character S in FIG. 7 indicates a step.

The first terminal apparatus 30-1 requests the server 10 to generate an application object (that is, the “application” object D6) (S301).

Specifically, the first terminal apparatus 30-1 requests the server 10 to generate an application object as a child object of the “vendor” object D3.

When receiving the request of the generation of the application object from the first terminal apparatus 30-1 (S101), the server 10 causes the token verification unit 103 (see FIG. 2) to verify an access token included in the request, and if the verification is successful, causes the scope execution unit 104 (see FIG. 2) to generate an application object (S102). The application object is generated in the object store 111 (see FIG. 2).

The server 10 transmits the ID of the generated application object (that is, the object ID) to the first terminal apparatus 30-1 (S103).

The first terminal apparatus 30-1 receives the object ID as a response from the server 10 (S302).

The first terminal apparatus 30-1 requests the server 10 to generate a token (that is, an application token) for generating a child object of the application object (that is, the “application” object D6) (S303).

When receiving the request of the generation of the application token from the first terminal apparatus 30-1 (S104), the server 10 verifies an access token included in the request, and if the verification is successful, generates an application token (S105).

The server 10 transmits the ID of the application token (that is, the token ID) to the first terminal apparatus 30-1 (S106).

The first terminal apparatus 30-1 receives the token ID as a response from the server 10 (S304).

The first terminal apparatus 30-1 requests the server 10 to generate a verification token (that is, the “Verify Token” object D9) (S305). The verification token is a token that is used for verifying a token (for example, a version token) embedded in an installer or an application, and is defined every application object.

When receiving the request of the generation of the verification token from the first terminal apparatus 30-1 (S107), the server 10 verifies an access token included in the request, and if the verification is successful, generates a verification token (S108). The verification token is generated in the object store 111 (see FIG. 2).

The server 10 transmits the ID of the verification token (that is, the token ID) to the first terminal apparatus 30-1 (S109).

The first terminal apparatus 30-1 receives the token ID as a response from the server 10 (S306).

### Generation of Version Object

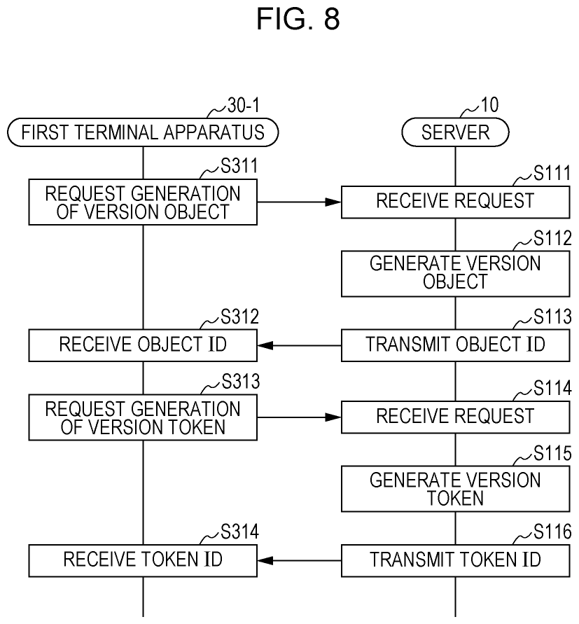

FIG. 8 illustrates a process of generating a version object to be executed between the server 10 and the first terminal apparatus 30-1 that is used by a vendor that provides an application.

The version object is generated when a vendor and a user make a contract of a license. Character S in FIG. 8 indicates a step.

The first terminal apparatus 30-1 requests the server 10 to generate a version object (that is, the “version” object D8) (S311).

Specifically, the first terminal apparatus 30-1 requests the server 10 to generate a version object as a child object of the “application” object D6. The request includes an access token.

When receiving the request of the generation of the version object from the first terminal apparatus 30-1 (S111), the server 10 causes the token verification unit 103 (see FIG. 2) to verify the access token included in the request, and if the verification is successful, causes the scope execution unit 104 (see FIG. 2) to generate a version object (S112). The version object is generated in the object store 111 (see FIG. 2).

In the version object, a major version, a minor version, and combination information are set. The combination information includes information on, for example, basic software on which the application is operable, the application being the object of license contract. The combination information includes information checked when the license is contracted, and is updated when the information is changed through the check of a server (not illustrated).

The server 10 transmits the ID of the generated version object (that is, the object ID) to the first terminal apparatus 30-1 (S113).

The first terminal apparatus 30-1 receives the ID of the version object as a response from the server 10 (S312).

The first terminal apparatus 30-1 requests the server 10 to generate a version token (that is, the “version Token” object D11) (S313). Specifically, the first terminal apparatus 30-1 requests the server 10 to generate a version token as a child object of the “version” object D8. The version token is identification information on the version of the application which is the object of license contract.

When receiving the request of the generation of the version token from the first terminal apparatus 30-1 (S114), the server 10 verifies an access token included in the request, and if the verification is successful, generates a version token (S115). The version token is generated in the object store 111 (see FIG. 2).

The server 10 transmits the ID of the version token (that is, the token ID) to the first terminal apparatus 30-1 (S116).

The first terminal apparatus 30-1 receives the token ID as a response from the server 10 (S314).

### Registration of License Object

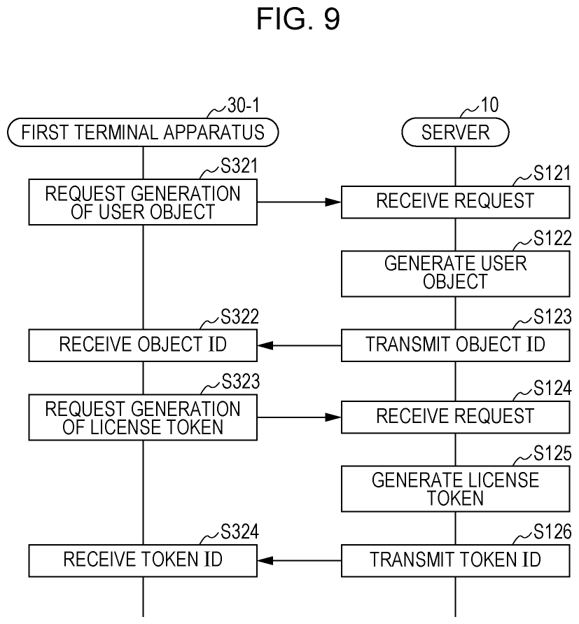

FIG. 9 illustrates a process of generating a license object to be executed between the server 10 and the first terminal apparatus 30-1 that is used by a vendor that provides an application.

The license object is generated when a vendor and a user make a contract of a license. Character S in FIG. 9 indicates a step.

The first terminal apparatus 30-1 requests the server 10 to generate a user object (that is, the “user On Version” object D14) (S321).

Specifically, the first terminal apparatus 30-1 requests the server 10 to generate a user object as a child object of the “version” object D8. The request includes an access token.

When receiving the request of the generation of the user object from the first terminal apparatus 30-1 (S121), the server 10 causes the token verification unit 103 (see FIG. 2) to verify the access token included in the request, and if the verification is successful, causes the scope execution unit 104 (see FIG. 2) to generate a user object (S122). The user object is generated in the object store 111 (see FIG. 2). In the user object, attribute information on a user is set.

The server 10 transmits the ID of the generated user object (that is, the object ID) to the first terminal apparatus 30-1 (S123).

The first terminal apparatus 30-1 receives the object ID as a response from the server 10 (S322).

The first terminal apparatus 30-1 requests the server 10 to generate a license token (that is, the “license Token” object D15) (S323). Specifically, the first terminal apparatus 30-1 requests the server 10 to generate a license token as a child object of the “user On Version” object D14. The license token indicates the current license given to the version.

If it is recognized that the version of the application in use is improper as the result of the verification on the authenticity of the version of the application in use, an interim object (that is, the “interim Token” object D16) or a hibernation object (that is, the “hibernation Token” object D17) is generated as a child object of the user object.

The server 10 transmits the ID of the license token (that is, the token ID) to the first terminal apparatus 30-1 (S126).

The first terminal apparatus 30-1 receives the token ID as a response from the server 10 (S324).

FIGS. 7 to 9 expect the data structure when the licensee is an individual. Even in a case where the licensee is a tenant, the version and license may be managed by a like procedure.

A token that indicates a version of an application installed in the second terminal apparatus 30-2 that is used by an individual user who participates in a tenant is generated in the “version Token” object D26 that is a child object of the “user In Tenant” object D24.

### Display of License-Related Management Screen

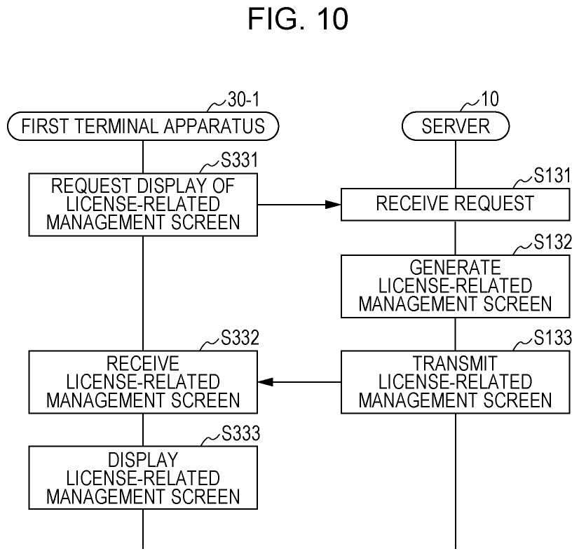

FIG. 10 illustrates a process of displaying a license-related management screen to be executed between the server 10 and the first terminal apparatus 30-1 that is used by the vendor of an application.

The process illustrated in FIG. 10 is executed at a certain timing after a license is contracted.

The first terminal apparatus 30-1 requests the server 10 to display a license-related management screen (S331). The request includes a version token (that is, the “version Token” object D11).

When receiving the request of the display of the license-related management screen from the first terminal apparatus 30-1 (S131), the server 10 verifies the version token included in the request, and if the verification is successful, generates a license-related management screen (S132).

The server 10 transmits the generated license-related management screen to the first terminal apparatus 30-1 (S133).

The first terminal apparatus 30-1 receives the license-related management screen as a response from the server 10 (S332).

The first terminal apparatus 30-1 displays the received license-related management screen (S333).

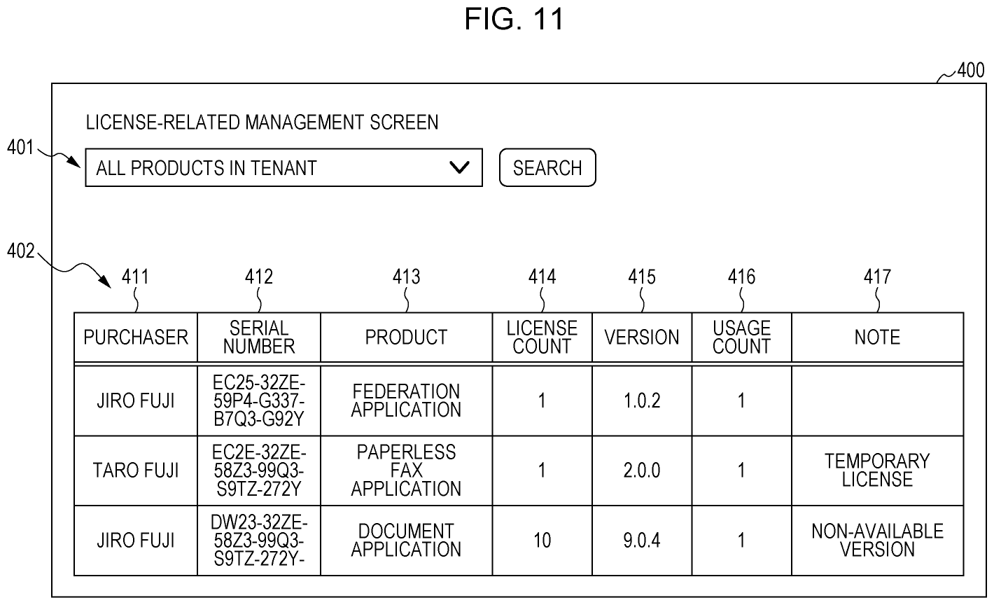

FIG. 11 illustrates an example of a license-related management screen 400.

The license-related management screen 400 illustrated in FIG. 11 includes a region 401 indicating an input field to designate an object to be searched, and a search execution button; and a display field 402 of search results.

In the case of FIG. 11, “all products in tenant” are designated as objects to be searched in the region 401.

The display field 402 in FIG. 11 includes purchaser 411, serial number 412, product 413, license count 414, version 415, usage count 416, and note 417.

The purchaser 411 in this case is a user who uses the product 413 in the tenant. In the case of FIG. 11, the purchaser 411 includes two persons of “Jiro FUJI” and “Taro FUJI”.

The serial number 412 is a number for identifying an individual of an application that is the product 413.

The product 413 is the name of an application. In the case of FIG. 11, the product 413 includes three applications of “federation application”, “paperless fax application”, and “document application”.

The license count 414 is the number of licenses per application owned by the tenant. For example, one license is given to the “federation application”, and one license is given to the “paperless fax application”. Ten licenses are given to the “document application”.

The version 415 is a version of the product 413 used by the purchaser 411. For example, the version 415 of the “federation application” used by Jiro FUJI is “1.0.2”.

The usage count 416 is the number by which each product 413 is used in the tenant. In the case of FIG. 11, each product is used by one.

The note 417 displays information about the product 413 used by each user. The note 417 displays information for notification on the difference between the state of usage and the recommended state of usage of the product 413, and the state of management corresponding to the difference. In the case of FIG. 11, it is found that a temporary license is given to the “paperless fax application” in use by Taro FUJI. Moreover, it is found that the “document application” in use by Jiro FUJI is a non-available version.

The license-related management screen 400 allows the manager of the tenant to check the version 415 of the application used by the user (that is, the purchaser 411) in the tenant.

The license-related management screen 400 also urges the manager of the tenant to perform updating or upgrading using the note 417 indicating whether the version in use is recommended.

The license-related management screen 400 may display either of the first terminal apparatus 30-1 used by the vendor that is the licenser and the second terminal apparatus 30-2 used by the individual user who is the licensee.

In the embodiment above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A license management system comprising:
a generating unit that generates first information to identify a version of an application program in use; and
a transmitting unit that transmits the first information to a manager.

2. The license management system according to claim 1, further comprising:
an associating unit that associates second information with the version identified using the first information, the second information indicating a license and generated in accordance with a result of verification that the version of an application to be managed is in a recommended state.

3. The license management system according to claim 2,
wherein the second information permits to make an access with a time limit to the application program in use.

4. The license management system according to claim 3,
wherein the second information is managed in association with a user associated with the version.

5. The license management system according to claim 2,
wherein the second information inhibits to make an access to the application program in use.

6. The license management system according to claim 5,
wherein the second information is managed in association with a user associated with the version.

7. The license management system according to claim 1,
wherein the first information is generated when a license of an application program is contracted.

8. The license management system according to claim 1, further comprising:
a managing unit that displays, on a screen to manage a license of at least one application program, a version of each of the at least one application program.

9. The license management system according to claim 8,
wherein the managing unit displays information relating to a result of verification of the version, in a manner associated with the version.

10. A non-transitory computer readable medium storing a program causing a computer to execute a process for managing information, the process comprising:
generating first information to identify a version of an application program in use; and
transmitting the first information to a manager.

11. A license management system comprising:
generating means for generating first information to identify a version of an application program in use; and
transmitting means for transmitting the first information to a manager.
